(19) United States
(12) Patent Application Publication
(10) Pub. No.: US 2022/0205545 A1
(43) Pub. Date: Jun. 30, 2022

(54) WIPER-SCRAPER WITH ENERGIZING SPRING

(71) Applicant: ROGER ZATKOFF COMPANY, Farmington Hills, MI (US)

(72) Inventors: David Zatkoff, Bloomfield Hills, MI (US); Paul Sutherland, Mason, OH (US)

(21) Appl. No.: 17/138,966

(22) Filed: Dec. 31, 2020

(51) Int. Cl. F16J 15/56; F16J 15/3232; F16J 15/3212

(52) U.S. Cl. CPC F16J 15/56; F16J 15/3212; F16J 15/3232

(57) ABSTRACT

A wiper-scraper comprising a can having an inner wall, an upper axial lip, and a lower axial lip is described. The upper and lower axial lips are disposed at opposite ends of the inner wall and define a first central opening and a groove. A wiper is disposed in the groove adjacent the lower axial lip. A scraper is disposed in the groove between the wiper and the upper axial lip and floats within the groove. The scraper defines a scraper channel facing toward the inner wall and an energizing spring is disposed in the scraper channel. The energizing spring has a serpentine shape and applies a biasing force between the inner wall and the scraper.

### BACKGROUND

The present disclosure relates to a wiper-scraper of a hydraulic cylinder. More specifically, the wiper-scraper may surround a rod of hydraulic cylinder to prevent debris from entering a chamber of the hydraulic cylinder. Prior art wipers, scraper and/or wiper-scrapers are generally larger in size, and often come as two separate parts. The present disclosure provide a compact, cost-effective, wiper-scraper.

### SUMMARY

According to one aspect of the disclosure, a wiper-scraper comprises a can having an inner wall, an upper axial lip, and a lower axial lip. The upper and lower axial lips are disposed at opposite ends of the inner wall and define a first central opening. The upper and lower axial lips of the can define a groove. A wiper is disposed in the groove adjacent the lower axial lip. A scraper is disposed in the groove between the wiper and the upper axial lip and the scraper floats within the groove. The scraper also defines a scraper channel facing toward the inner wall. A spring or energizing spring is disposed in the scraper channel and applies a biasing force between the inner wall and the scraper.

According to one aspect of the disclosure, a wiper-scraper comprises a can having an inner wall, an upper axial lip, and a lower axial lip. The upper and lower axial lips are disposed at opposite ends of the inner wall and define a first central opening. The upper and lower axial lips of the can define a groove. A wiper and a scraper is disposed in the groove and the scraper floats within the groove. A spring engages and applies a biasing force between the inner wall and the scraper. The wiper and the scraper each are disposed in the groove with the wiper being adjacent the lower axial lip and the scraper being between and adjacent the wiper and the upper axial lip. The can, the wiper, and the scraper are coaxial with one another. A width of the groove may be defined by a first upper surface of the upper axial lip and a second upper surface of the lower axial lip.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or” is inclusive, meaning and/or. Moreover, the terminology used herein is for the purpose of describing particular example embodiments only, and is not intended to be limiting. As used herein, the singular forms “a,” “an,” and “the” may be intended to include the plural forms as well, unless the context clearly indicates otherwise.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” “top,” “bottom,” “right,” “left,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates an exploded view of a wiper-scraper according to principles of the present disclosure.

FIG. 2 generally illustrates a perspective view of the wiper-scraper according to principles of the present disclosure.

FIG. 3 generally illustrates a top view of the wiper-scraper according to principles of the present disclosure.

FIG. 4 generally illustrates a sectional view, taken along line A-A of FIG. 3, of the wiper-scraper according to principles of the present disclosure.

FIG. 5 generally illustrates a detailed view, taken at detail D of FIG. 4, of an embodiment of the wiper-scraper according to principles of the present disclosure.

FIG. 6 generally illustrates a detailed view, taken at detail D of FIG. 4, of an embodiment of the wiper-scraper according to principles of the present disclosure.

### DETAILED DESCRIPTION

The following discussion is directed to various embodiments of the present disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

With reference to the FIGS., a wiper-scraper 20 of the present disclosure is illustrated. The wiper-scraper 20 comprises a can 22, a scraper 24, a wiper 26 and an energizing spring 28. The wiper-scraper 20 may be formed in a ring shape or any other desired shape. The wiper-scraper 20 may couple to a hydraulic cylinder to clean debris from a rod that oscillates into and out of a chamber of the hydraulic cylinder. The wiper-scraper 20 may couple to the hydraulic cylinder such the rod extends through a first central opening 38 of the wiper-scraper. Although the wiper-scraper 20 is described herein as being used in connection with a hydraulic cylinder, it is to be appreciated the wiper-scraper 20 may be used in a wider variety of application. For example, the wiper-scraper 20 may be used in any mechanical apparatus that may include one or more moving rods, cylinders, arms or the like to prevent debris from entering a joint, juncture, chamber or the like between two elements that oscillate relative to one another.

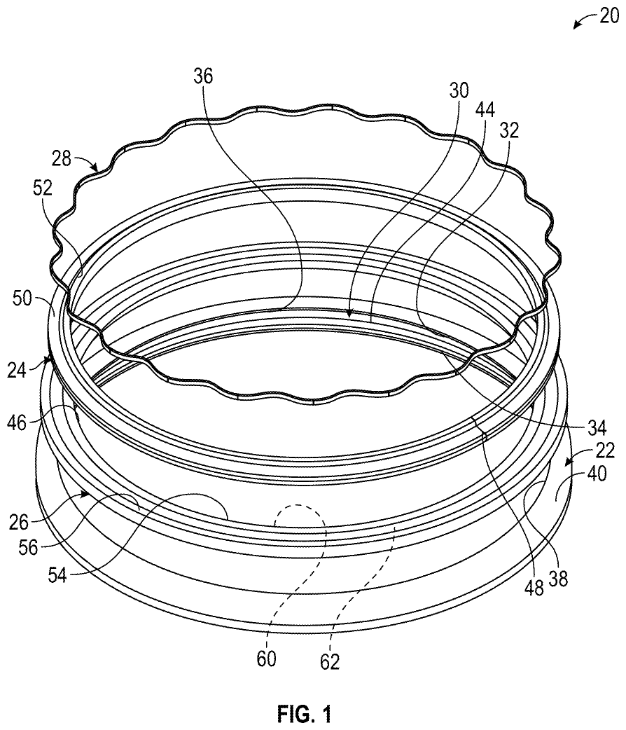

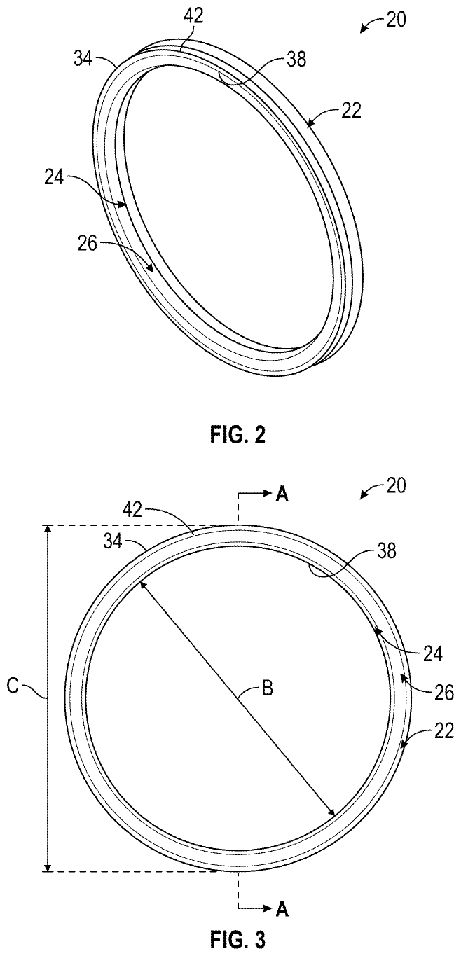

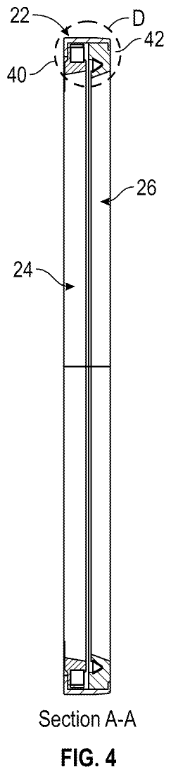

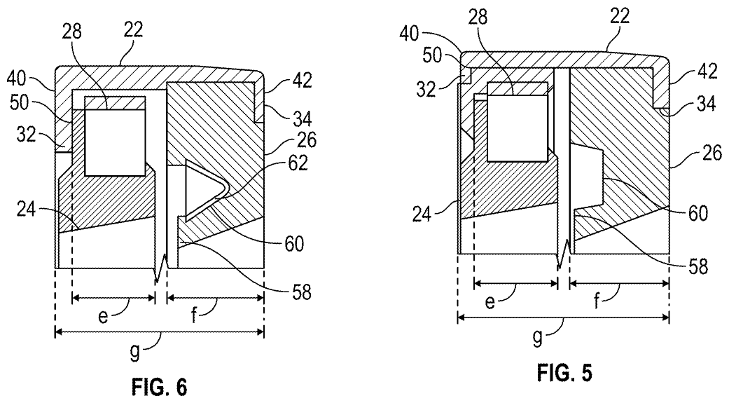

The can 22 may have an inner wall 30, an upper axial lip 32, and a lower axial lip 34. The upper and lower axial lips 32, 34 may be disposed at opposite ends of the inner wall 30, and the axial lips 32, 34 and the inner wall 30 may define a groove 36. The upper and lower axial lips 32, 34 may also define the first central opening 38 of the can 22. The scraper 24, the wiper 26, and the energizing spring 28 can be disposed between the upper and lower axial lips 32, 34 and at least partially disposed in the groove 36. The scraper 24, the wiper 26, and the energizing spring 28 may also be coaxially aligned with the can 22. The scraper 24 may be disposed adjacent the lower axial lip 34 in the groove 36, and the wiper 26 may be disposed adjacent the upper axial lip 32 in the groove 36. Of course, the scraper 24 or the wiper 26 may be disposed adjacent either axial lip 32, 34. In some embodiments, such as those illustrated in FIGS. 1 and 6, the inner wall 30 may have a ledge 44 and the ledge 44 may support the wiper 26. In some embodiments, such as the embodiment generally illustrated in FIG. 5, the inner wall 30 may not have a ledge.

The can 22 may be formed from metallic material, such as, a 300 series stainless steel, a copper alloy, or any other desired material. The can 22 may be formed from non-metallic material, such as a plastic or any other desired material. The can 22 may be formed in a molding, stamping, machining, or any other know process. The can 22 maintains its shape during operation of the industrial apparatus to secure the wiper-scraper 20 to the cylinder and to maintain the relative positions of the scraper 24, the wiper 26, and the spring 28 to each other and to the can 22. A width g (see FIGS. 5-6) of the can 22 may be defined by a first outer surface 40 of the upper axial lip 34 and a second outer surface 42 of the lower axial lip 32.

The width g may have a range of values. In some embodiments, the width g of the can 22 may be approximately 0.297 inches to 0.392 inches. In some embodiments, the width g of the can 22 may be approximately 0.297 inches to 0.392 inches. In some embodiments, the width g of the can 22 may be less then approximately 0.329 inches. Although values of the width g are provided herein, the width g is not limited by these values.

The scraper 24 may be disposed in the groove 36 between and adjacent the wiper 26 and the upper axial lip 32. The scraper 24 may be formed from brass, bronze, copper, stainless steel, hard plastic, any other suitable material, or combination thereof. The scraper 24 may define a ring shape and define a second central opening 46 (see FIG. 1). The second central opening 46 may be aligned coaxial with, and smaller in size (e.g., have a smaller diameter) than, the first central opening 38. Moreover, the scraper 24 may also be smaller in size (e.g., have a smaller diameter and/or width) than the can 22. The scraper 24 may also define a slit 48 designed to allow the scraper 24 to flex radially. The slit 48 and the smaller size of the scraper 24 allows the scraper 24 to float (i.e., move axially and radially) within the groove 36. In some embodiments, the scraper 24 may float between the wiper 26 and the upper axial lip 32. In some embodiments, the scraper 24 defines a first shelf 50 about a perimeter and the first shelf 50 engages the upper axial lip 32 as the scraper 24 floats.

In some embodiments, the scraper 24 defines a scraper channel 52. When the scraper 24 is disposed in the groove 36, the scraper channel 52 may face towards (i.e., be open to) the inner wall 30. An energizing spring 28 may be disposed in the scraper channel 52. The energizing spring 28 may have a serpentine shape or any other desired shape. The serpentine shape of the energizing spring 28 may include a plurality of sinusoidal waves having irregular amplitudes and lengths. When the scraper 24, with the energizing spring 28 disposed in the scraper channel 52, is disposed in the groove 36, the energizing spring 28 may apply a biasing force between the inner wall 30 and the scraper 24 to bias against radial flexing of the scraper 24. Moreover, the energizing spring 28 maintains a radial compression against the scraper 24, and in turn, the scraper 24 against the rod. When radially compressed against the rod, the scraper 24 can scrape debris from the rod as it oscillates into and out of the chamber of the hydraulic cylinder.

The wiper 26 may define a ring shape and define a third central opening 54. The wiper 26 may be formed from thermoplastic polyurethane, polytetrafluoroethylene (with or without filler elements), thermoplastic elastomer, among many other rubber and non-rubber materials, or combination thereof. The third central opening 54 may be aligned coaxial with, and smaller in size (e.g., have a smaller diameter) than, the first central opening 38. Moreover, the wiper 26 may also be smaller in size (e.g., have a smaller diameter and/or width) than the can 22. The wiper 26 may define a second shelf 56 about a perimeter. The second shelf 56 may engage and rest on the ledge 44. In some embodiments, the second shelf 56 may engage the scraper 24 as the scraper 24 floats in the groove 36. The wiper 26 may comprises a bottom surface 58 that defines a wiper channel 60. An elastic element or fatigue spring 62 can be disposed in the wiper channel 60. The fatigue spring 62 can limit deformation of the wiper 26 and can causes the wiper 26 to compress radially. The fatigue spring 62 is configured to help to maintain the shape of the wiper 26 by compressing the wiper 26 radially, and in turn, the wiper 26 against the rod. When compressed against the rod, the wiper 26 forms a seal between the rod and the wiper 26.

Consistent with the above disclosure, the examples of systems and methods enumerated in the following clauses are specifically contemplated and are intended as a non-limiting set of examples.

Clause 1. A wiper-scraper, comprising: a can having an inner wall, an upper axial lip, and a lower axial lip, wherein the upper and lower axial lips are disposed at opposite ends of the inner wall and define a first central opening and a groove; a wiper disposed in the groove adjacent the lower axial lip; a scraper disposed in the groove between the wiper and the upper axial lip, wherein the scraper floats within the groove; the scraper defines a scraper channel facing toward the inner wall; and a spring disposed in the scraper channel and having a serpentine shape and applying a biasing force between the inner wall and the scraper.

Clause 2. The wiper-scraper of any preceding clause, wherein the serpentine shape of the spring includes a plurality of sinusoidal waves having irregular amplitudes and lengths.

Claus 3. The wiper-scraper of any preceding clause, wherein the scraper has a ring shape and defines a second central opening that is aligned coaxially with the first central opening and the second central opening being smaller in size than the first central opening.

Clause 4. The wiper-scraper of any preceding clause, wherein the scraper defines a slit allowing the scraper to flex radially.

Clause 5. The wiper-scraper of any preceding clause, wherein the scraper defines a first shelf about a perimeter and the first shelf engages the upper axial lip as the scraper floats.

Clause 6. The wiper-scraper of any preceding clause, wherein the inner wall comprises a ledge and the ledge supports the wiper in the groove.

Clause 7. The wiper-scraper of any preceding clause, wherein the wiper defines a second shelf about a perimeter.

Clause 8. The wiper-scraper of any preceding clause, wherein the scraper is disposed in the groove between the ledge and the lower axial lip.

Clause 9. The wiper-scraper of any preceding clause, wherein the wiper has a ring shape defines a third central opening that is aligned coaxially with the first central opening and the third central opening being smaller in size than the first central opening.

Clause 10. The wiper-scraper of any preceding clause, wherein the wiper comprises a bottom surface defining a wiper channel.

Clause 11. The wiper-scraper of any preceding clause, wherein an elastic element is disposed in the wiper channel and the elastic element prevents deformation of the wiper.

Clause 12. The wiper-scraper of any preceding clause, where the can is formed from at least one of a metallic material, a 300 series stainless steel, a copper alloy, and a molding process.

Clause 13. The wiper-scraper of any preceding clause, wherein a width of the can is defined by a first outer surface of the upper axial lip and a second outer surface of the lower axial lip.

Clause 14. The wiper-scraper of any preceding clause, wherein the width is approximately 0.297 inches to 0.392 inches.

Clause 15. The wiper-scraper of any preceding clause, wherein the width is less then approximately 0.329 inches.

Clause 16. A wiper-scraper, comprising: a can having an inner wall, an upper axial lip, and a lower axial lip, wherein the upper and lower axial lips are disposed at opposite ends of the inner wall and define a central opening and a groove; a wiper disposed in the groove; a scraper disposed in the groove and floating within the groove; a spring engaging, and applying a biasing force between, the inner wall and the scraper; wherein the wiper and the scraper are each disposed in the groove with the wiper being adjacent the lower axial lip and the scraper being between and adjacent the wiper and the upper axial lip, and the can, the wiper and the scraper being coaxial with one another; and a width of the groove is defined by a first upper surface of the upper axial lip and a second upper surface of the lower axial lip.

Clause 17. The wiper-scraper of any preceding clause, wherein the width is defined as being approximately 0.297 inches to 0.329 inches.

Clause 18. The wiper-scraper of any preceding clause, wherein the width is less than approximately 0.33 inches.

Clause 19. The wiper-scraper of any preceding clause, wherein the spring has a serpentine shape and the serpentine shape includes a plurality of sinusoidal waves having irregular amplitudes and lengths.

Clause 20. The wiper-scraper of any preceding clause, wherein the scraper defines a slit allowing the scraper to flex radially.

No part of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

The foregoing description, for purposes of explanation, use specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present invention. Once the above disclosure is fully appreciated, numerous variations and modifications will become apparent to those skilled in the art. It is intended that the following claims be interpreted to embrace all such variations and modifications.

What is claimed is:

1. A wiper-scraper, comprising:
a can having an inner wall, an upper axial lip, and a lower axial lip, wherein the upper and lower axial lips are disposed at opposite ends of the inner wall and define a first central opening and a groove;
a wiper disposed in the groove adjacent the lower axial lip;
a scraper disposed in the groove between the wiper and the upper axial lip, wherein the scraper floats within the groove between the wiper and the upper axial lip;
the scraper defines a scraper channel facing toward the inner wall; and
a spring disposed in the scraper channel and the spring applies a biasing force between the inner wall and the scraper.

2. The wiper-scraper of claim 1, wherein the spring has a serpentine shape and includes a plurality of sinusoidal waves having irregular amplitudes and lengths.

3. The wiper-scraper of claim 1, wherein the scraper has a ring shape and defines a second central opening that is aligned coaxially with the first central opening and the second central opening being smaller in size than the first central opening.

4. The wiper-scraper of claim 1, wherein the scraper defines a slit allowing the scraper to flex radially.

5. The wiper-scraper of claim 1, wherein the scraper defines a first shelf about a perimeter and the first shelf engages the upper axial lip as the scraper floats.

6. The wiper-scraper of claim 5, wherein the inner wall comprises a ledge that is shaped to supports the wiper.

7. The wiper-scraper of claim 6, wherein the wiper defines a second shelf about the perimeter.

8. The wiper-scraper of claim 7, wherein the scraper is disposed in the groove between the ledge and the lower axial lip.

9. The wiper-scraper of claim 1, wherein the wiper defines a ring shape defines a third central opening that is aligned coaxially with the first central opening, the third central opening being smaller in size than the first central opening.

10. The wiper-scraper of claim 1, wherein the wiper comprises a bottom surface defining a wiper channel.

11. The wiper-scraper of claim 10, wherein an elastic element is disposed in the wiper channel and the elastic element prevents deformation of the wiper.

12. The wiper-scraper of claim 1, where the can is formed from at least one of a plastic material, metallic material, a 300 series stainless steel, a copper alloy, and a molding process.

13. The wiper-scraper of claim 1, wherein a width of the can is defined by a first outer surface of the upper axial lip and a second outer surface of the lower axial lip.

14. The wiper-scraper of claim 13, wherein the width is approximately 0.297 inches to 0.392 inches.

15. The wiper-scraper of claim 13, wherein the width is less then approximately 0.329 inches.

16. A wiper-scraper, comprising:
a can having an inner wall, an upper axial lip, and a lower axial lip, wherein the upper and lower axial lips are disposed at opposite ends of the inner wall and define a central opening and a groove;
a wiper disposed in the groove;
a scraper disposed in the groove and floating within the groove;
a spring engaging, and applying a biasing force between, the inner wall and the scraper;
wherein the wiper and the scraper are each disposed in the groove with the wiper being adjacent the lower axial lip and the scraper being between and adjacent the wiper and the upper axial lip, and the can, the wiper and the scraper being coaxial with one another; and
a width of the groove is defined by a first upper surface of the upper axial lip and a second upper surface of the lower axial lip.

17. The wiper-scraper of claim 16, wherein the width is defined as being approximately 0.297 inches to 0.329 inches.

18. The wiper-scraper of claim 16, wherein the width is less than approximately 0.33 inches.

19. The wiper-scraper of claim 16, wherein the spring has a serpentine shape and the serpentine shape includes a plurality of sinusoidal waves having irregular amplitudes and lengths.

20. The wiper-scraper of claim 16, wherein the scraper defines a slit allowing the scraper to flex radially.
